(19) United States
(12) Patent Application Publication
(10) Pub. No.: US 2003/0040209 A1
(43) Pub. Date: Feb. 27, 2003

(54) Electric plug connector having an integrated secondary lock

(76) Inventor: Roman Hoernle, Weissach (DE)

Correspondence Address: KENYON & KENYON, ONE BROADWAY, NEW YORK, NY, 10004, US

(21) Appl. No.: 10/216,142

(22) Filed: Aug. 9, 2002

(30) Foreign Application Priority Data
Aug. 9, 2001 (DE) 201 13 203.6

(51) Int. Cl. H01R 4/50

(52) U.S. Cl. 439/345

(57) ABSTRACT

A secondary lock of an electric plug connection includes two function parts, the first function part being composed of at least two pin-like elements which are oriented in the direction of plug insertion and are movable back and forth perpendicularly to the direction of plug insertion, and cooperate with additional pin-like elements fixedly arranged in the second function part and oriented opposite the direction of plug insertion, so that the free ends of the two pin-like elements are in contact in the opened state of the secondary lock, and they are situated side by side in the locked state of the secondary lock. By displacing the support in the direction of the arrow, the secondary lock may be brought to its end position. In doing so, the elements slide into the interspace until they reach the end position.

### FIELD OF THE INVENTION

The present invention relates to an electric plug connector including a plug and a mating connector, the plug having a casing and a contact strip situated in the casing, contact elements being arranged in the contact strip, and having a primary lock and a secondary lock, and the mating connector has a casing and a contact strip situated in the casing, contact elements being situated in the contact strip.

### BACKGROUND INFORMATION

Plug connectors of the type described above are known in a wide variety of embodiments. They usually have a primary lock to secure the electric connection between the plug and the mating connector and they have a secondary lock. The secondary lock is used to determine whether the corresponding electric contacts have been completely established between the plug and the mating connector. If this is the case, the secondary lock may be brought from an open state into a locked state. If a contact is not closed, the secondary lock cannot be brought into the locked state.

Although the plug connection may be plugged in this state, so that the plug and the mating connector enter into a mechanical connection, the electric connection cannot be established even by pressing the plug further into the mating connector.

### SUMMARY OF THE INVENTION

An object of the present invention is to provide an electric plug connection using which it is possible to check by a simple method on whether the electric connection between the plug and the mating connector has been established completely. If the secondary lock is not closed, it should be impossible to close the plug connection.

This object is achieved by the fact that the secondary lock has two function parts, the first function part being composed of at least two pin-like elements oriented, movably back and forth at right angles to the direction of plug insertion in the direction of plug insertion, and cooperating with additional pin-like elements fixedly arranged in the second function part and oriented opposite the direction of plug insertion, so that when the secondary lock is in an opened state, the free ends of the two pin-like elements are in contact, and when the secondary lock is in the locked state, they are arranged side by side.

### SUMMARY OF THE INVENTION

Due to the simple design and use of the secondary lock according to the present invention in electric plug connections, it is possible to ensure that proper connections may be established.

Due to the comb-like design of the pin-like elements, appropriate patterns of joinable elements may be created in the plug and the mating connector so that it is possible to ensure that only suitably fitting plugs and mating connectors may be joined together despite the same size of contact strips and/or an identical arrangement of contact elements.

### BRIEF DESCRIPTION OF THE DRAWINGS

FIG. 1 shows a schematic diagram of the functioning of the secondary lock according to the present invention in an open position.

FIG. 2 shows a schematic diagram of the functioning of the secondary lock according to the present invention as illustrated in FIG. 1, except that, in contrast to FIG. 1, a locked position is illustrated.

### DETAILED DESCRIPTION

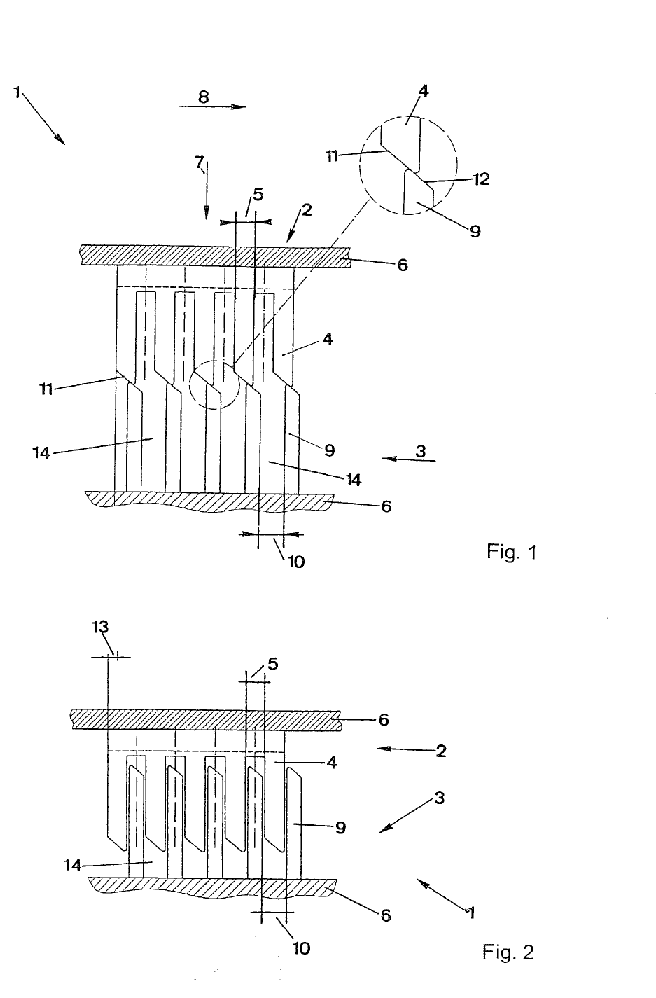

FIGS. 1 and 2 illustrate a secondary lock 1 composed of a first function part 2, a plug (not shown in the drawing) and another function part 3, which is assigned to a mating connector (not shown in the drawing).

First function part 2 has pin-like elements 4 arranged side by side on a support 6 at a defined distance 5. Elements 4 extend in the direction of plug insertion (arrow 7) and are aligned parallel to one another. As an alternative to this, a spatial arrangement of elements 4 is also conceivable. Support 6 is movable back and forth together with elements 4 perpendicularly to the direction of plug insertion (arrow 8).

Additional function part 3 is fixedly mounted in a mating connector, preferably a multipoint plug. Pin-like elements 9 extend opposite the direction of plug insertion (arrow 7) and are also mounted side by side and aligned in parallel at a defined distance 10.

Elements 4, 9 together with support 6 for elements 4 are preferably made of plastic.

The operation of the device is as follows:

The plug is placed on the mating connector, with secondary lock 1 in the “open” position as illustrated in FIG. 1. The plug may be pressed onto the mating connector in the direction of plug insertion (arrow 7) until the free ends of elements 4 of first function part 2 of the secondary lock come in contact with the free ends of elements 9 of second function part 3.

The free ends of elements 4, 9 preferably have oblique surfaces 11, 12. Because of this design, first function part 2 may be displaced by a displacement path 13 in the direction of the arrow, so that elements 4 are arranged above an interspace 14. This interspace 14 has a width corresponding at least to the width of elements 4. In this position, the plug may be brought to its end position, where elements 4 slide into interspace 14 until reaching the end position illustrated in FIG. 2.

What is claimed is:

1. An electric plug connection comprising:
a plug including a casing, a contact strip situated in the casing, contact elements situated in the contact strip, a primary lock and a secondary lock, the secondary lock including first and second function parts, the first function part including at least two pin-like elements oriented in a direction of plug insertion and movable back and forth perpendicularly to the direction of plug insertion, the two pin-like elements cooperating with additional pin-like elements fixedly arranged in the second function part and oriented opposite the direction of plug insertion, the two pin-like elements having free ends which are in contact in an opened state of the secondary lock and are situated side by side in a locked state of the secondary lock; and
a mating connector including a casing, a contact strip situated in the casing and contact elements situated in the contact strip.

2. The plug connection according to claim 1, wherein the two pin-like elements have oblique surfaces at the free ends.

3. The plug connection according to claim 2, wherein the oblique surfaces of the pin-like elements of the first function part slide on the oblique surfaces of the second function part to establish the locked state.

4. The plug connection according to claim 1, wherein the pin-like elements are situated on a support.

5. The plug connection according to claim 1, wherein the pin-like elements are situated along a side wall inside the casing of the plug and have a comb-like design.

6. The plug connection according to claim 1, wherein the pin-like elements are situated along a side wall inside the casing of the mating connector and have a comb-like design.
